(19) United States
(12) Patent Application Publication
(10) Pub. No.: US 2015/0161446 A1
(43) Pub. Date: Jun. 11, 2015

(54) 2D/3D ANALYSIS AND RENDERING OF UTILITIES, VALVES, INFORMATION AND ASSETS INTO VIDEO

(71) Applicant: Eliot Kirkpatrick, Indianapolis, IN (US)

(72) Inventor: Eliot Kirkpatrick, Indianapolis, IN (US)

(21) Appl. No.: 14/183,924

(22) Filed: Feb. 19, 2014

Related U.S. Application Data
(60) Provisional application No. 61/914,140, filed on Dec. 10, 2013.

(51) Int. Cl. G06K 9/00; G06K 9/28; H04N 5/278; H04N 7/18

(52) U.S. Cl. CPC G06K 9/00637; H04N 7/185; G06K 9/00651; G06K 9/00711; G06K 9/00791; G06K 9/28; H04N 5/278

(57) ABSTRACT

A video arrangement includes a camera capturing video images of a roadway as the camera is carried by a motor vehicle along the roadway. Locations of the vehicle are determined in association with the video images captured by the camera. A video processing circuit retrieves information about an asset associated with the roadway, the information including a location of the asset. The information is superimposed as text onto the video images. The text is disposed at respective positions within the video images. The positions are indicative of the location of the asset relative to the roadway.

### RELATED APPLICATIONS

This application is a non-provisional of, and claims the benefit of, provisional application 61/914,140, filed Dec. 10, 2013, entitled “2D/3D Analysis and Rendering of Utilities, Valves, Information and Assets into Video”, by applicant Eliot Kirkpatrick, which is hereby incorporated by reference herein in its entirety.

### BACKGROUND OF THE INVENTION

1. Field of the Invention

This invention may relate to associating information with video footage and storing the information in association with particular portions of the video footage.

2. Description of Related Art

Currently, there are a number of ways to document important assets within a construction (or deconstruction) project, with pictures and videos being the most predominant. For example, if there is to be road or sidewalk construction done on a project, documentation may be taken of all utilities, valves, hydrants, and other important assets so they remain intact throughout the work period of the project and to establish liability on the part of the contractor hired in the event that some damage occurs during the project.

### BRIEF SUMMARY

The present invention may incorporate motion tracking and data implementation into a previously shot video of an area that will undergo future change (e.g., construction, landscaping, etc.). Once a video is captured of a designated area that will undergo change, information associated with assets may be gathered and, once collected, may be placed into the video by means of motion tracking and 2D/3D rendering software. The final product may contain each asset/valve/utility, and each asset/valve/utility may be individually documented, including associated measurements, asset numbers, addresses, and any other information that may be available.

The stored information may include results of the identification, rendering, and motion tracking of a video to display certain assets and information corresponding to the assets in video format. Generally, the method of the invention may include graphically depicting information into moving video for any asset or item of interest. These assets along with their information may move through the field of view in a first person style of vision.

The invention may enhance a video style by rendering asset information onto a video display. Every asset may be individually documented and labeled to move through the three-dimensional plane of the video taken of each project.

The invention comprises, in one embodiment, a video arrangement including a camera capturing video images of a roadway as the camera is carried by a motor vehicle along the roadway. Locations of the vehicle are determined in association with the video images captured by the camera. A video processing circuit retrieves information about an asset associated with the roadway, the information including a location of the asset. The information is superimposed as text onto the video images. The text is disposed at respective positions within the video images. The positions are indicative of the location of the asset relative to the roadway.

The invention comprises, in another embodiment, a video processing method, including capturing a plurality of video images of a roadway. Information about an asset associated with the roadway is retrieved. The information includes a location of the asset. The information is superimposed as text onto the video images. The text is disposed at respective positions within the video images. The positions are indicative of the location of the asset relative to the roadway.

The invention comprises, in yet another embodiment, a video arrangement including a camera capturing video images of an external environment as the camera is carried by a motor vehicle. Means determines a plurality of locations of the vehicle in association with the video images captured by the camera. A video processing circuit retrieves information about an asset associated with the external environment. The information includes a location of the asset. The information is superimposed as text onto the video images. The text is disposed at respective positions within the video images. The positions are indicative of the location of the asset within the video frames.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a block diagram of one embodiment of a video arrangement of the present invention;

FIG. 2 is a flow chart of one embodiment of a video recording method of the present invention; and

FIG. 3 is a plan view of an example video screen display produced by the arrangement of FIG. 1.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

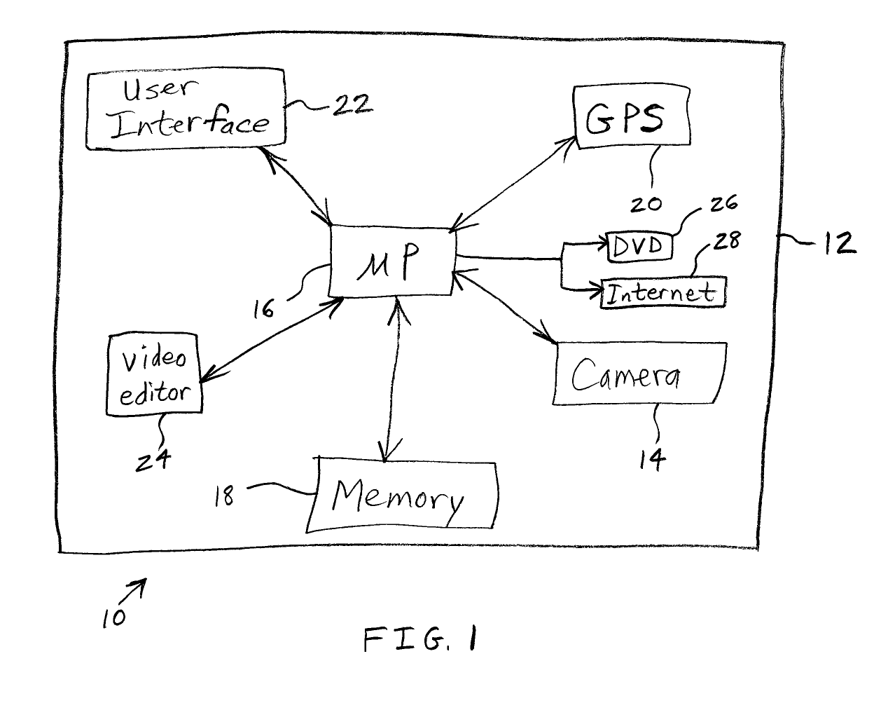

One embodiment of an apparatus of the present invention in the form of a video arrangement 10 is shown in FIG. 1. Arrangement 10 may be disposed within a motor vehicle 12. However, all components with the possible exception of camera 14 may alternatively be disposed at a remote location and not be carried by vehicle 12. Arrangement 10 also includes a processor 16, a memory device 18, a global positioning device (GPS) 20, a user interface 22 and a video editor 24. Processor 16 may be in bi-directional communication with each of the other components of arrangement 10. Processor 16 and video editor 24 may conjunctively form a video processing circuit.

During use, vehicle 12 may travel along streets with camera 14 operating and capturing video images of the streets. GPS 20 may operate continuously while camera operates, and processor 16 may associate each frame of video with a respective set of GPS coordinates. Memory 18 may include a list of assets associated with the streets, and the GPS coordinates of each of those assets may be stored in memory 18 in association with each of the assets. Processor 16 may use the retrieved GPS locations of the assets to superimpose a textual identification of each of the assets on the video frames. Each of the textual identifications may be located on the frames at a location corresponding to the GPS-determined location of the respective asset. For greater precision, arrows may also be superimposed on the frames to show more exact locations on the ground or streets that correspond to the locations of the various assets. The assets may be buried below ground, and hence may not be visible in the video frames. A user may use user interface 22 to add to the textual descriptions or identifications of the assets that are displayed on the video frames. For example, user interface 22 may include a keyboard or voice recognition equipment and software to enable the inputting of text. The identifications or descriptions of the assets may include an asset name or number, a street address of the assets, type of casting, and measurements of the distance of the assets from landmarks, such as cross streets (e.g., streets crossing the street being traveled on) or from one of the two curbs of the street being traveled on.

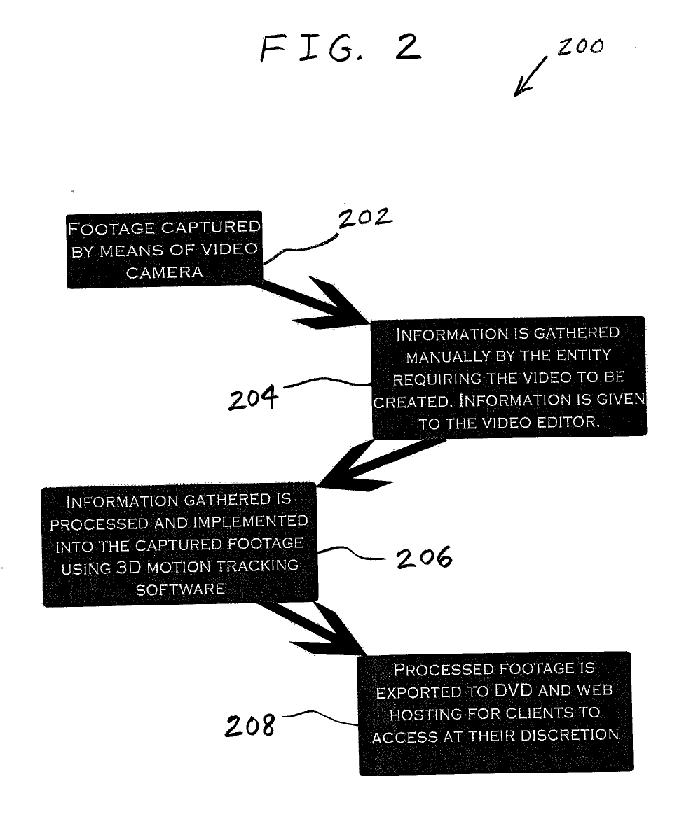

FIG. 2 is a flow chart of one embodiment of a video recording method 200 of the present invention. Method 200 may result in the capturing and implementing of video and textual information into a final video format for the end user (client) to use upon demand.

In a first step 202, footage is captured by use of a video camera. For example, camera 14 may capture video footage as vehicle 12 travels along streets. It is also possible for a camera to be carried by a robotic device or by a pedestrian as footage is captured.

In a next step 204, information is gathered manually by the entity that is requiring the video to be created. Information is given to the video editor. For example, identifications, descriptions and locations of the assets that are associated with the street images captured in the footage are collected by performing measurements on the streets and/or collecting existing asset data from other sources. The collected information may be entered into video editor 24 via user interface 22 and processor 16, for example. The information may also be stored in memory 18.

Next, in step 206, the information that has been gathered in step 204, may be processed and implemented into the captured footage using three-dimensional motion tracking software. That is, motion tracking software running on processor 16 may superimpose text information about assets into the individual frames of video footage with arrows indicating the precise locations of the assets in the individual frames. As the vehicle moves relative to the street, the locations of the text and arrows in the individual video frames may change or shift, as determined by the 3D motion tracking software, due to the changing locations of the assets within the individual video frames. For example, the location near a curb of a street being traveled on may move from the center portion of the frames to the side portions of the frames as the asset is approached and eventually passed.

In a final step 208, processed footage is exported to DVD and web hosting for clients to access at their discretion. That is, the video footage with the text information superimposed thereon may be stored on a digital video disc (DVD) 26 (FIG. 1) or may be made available on the Internet 28.

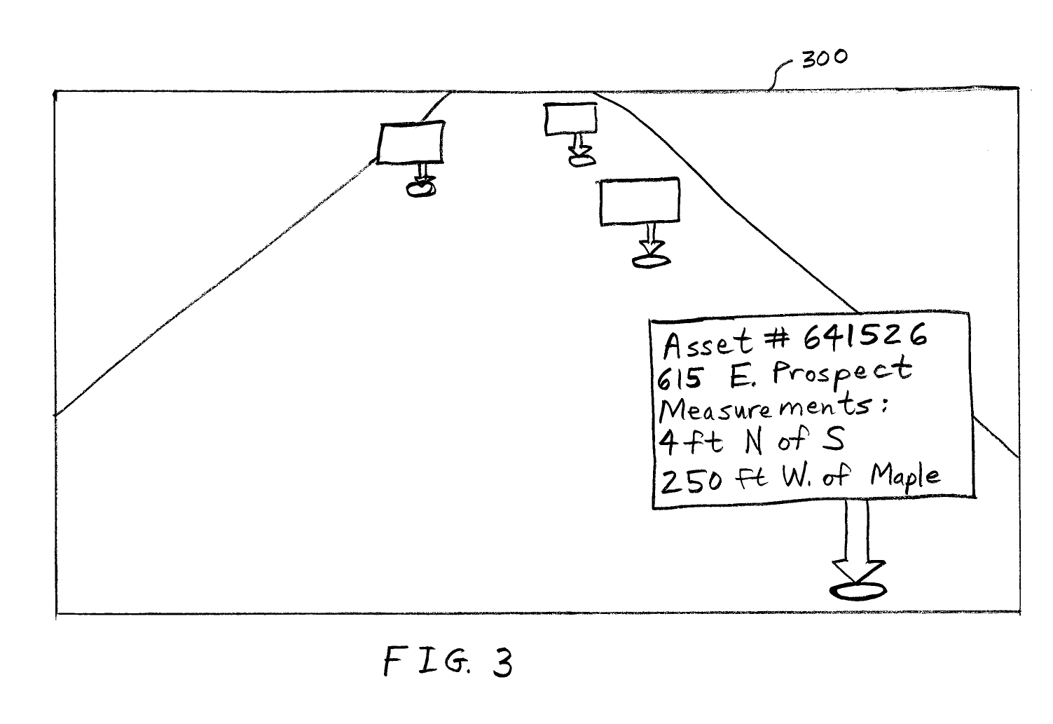

FIG. 3 is a plan view of an example video screen display 300 produced by the arrangement of FIG. 1. A natural gas valve is shown in the lower right-hand corner of the screen with an arrow pointing to the valve. A flag displays text information related to the valve. In one embodiment, the flag includes black lettering on a yellow background to display a natural gas color code. That is, the yellow background may indicate to the user that the asset is related to natural gas. The information may include the asset number, address, and measurements. Three upcoming, or more distant, utilities/assets are visible in the background of FIG. 3. The text associated with these three farther away assets may get larger and move more into view as video progresses and the vehicle continues to travel along the street.

The names of cross streets in the distance may be superimposed in the video frames. Other types of assets may have a different color coded text background. For example, a flag associated with a sanitary sewer utility may have a green background with black text. Other upcoming utilities and street signs may be color coded as appropriate. For example, a superimposed street sign of an upcoming cross street may have white lettering on a dark green background. A flag associated with a water utility may have a blue background and black text to indicate that the asset is related to a water utility.

The invention has been described herein as illustrating the location of assets relative to a roadway. However, it is to be understood that the invention is applicable to a vehicle traveling in any external environment which may or may not include streets or roadways. For example, the invention may be applied to a boat traveling along a waterway, or to an off-road vehicle traveling in an off-road environment that does not have any established paths, streets or roadways.

Although this invention has been described in specific detail, it will be understood that many variations and modifications may be effected within the scope and spirit of the invention as described in the description and claims.

What is claimed is:

1. A video arrangement, comprising:
a motor vehicle;
a camera configured to capture video images of a roadway as the camera is carried by the motor vehicle along the roadway;
means for determining a plurality of locations of the vehicle in association with the video images captured by the camera; and
a video processing circuit configured to:
retrieve information about an asset associated with the roadway, the information including a location of the asset; and
superimpose the information as text onto the video images, the text being disposed at respective positions within the video images, the positions being indicative of the location of the asset relative to the roadway.

2. The arrangement of claim 1, wherein the video processing circuit is configured to:
retrieve a name of a street that crosses the roadway; and
superimpose the name as text onto the video images.

3. The arrangement of claim 1, wherein the determining means comprises a global positioning system.

4. The arrangement of claim 1, wherein the video processor is configured to superimpose an arrow on the video images, the arrow pointing to the location of the asset.

5. The arrangement of claim 1, wherein the video processing circuit is configured to export the video images with the text information superimposed thereon to a digital video disc.

6. The arrangement of claim 1, wherein the video processing circuit is configured to export the video images with the text information superimposed thereon to the Internet.

7. The arrangement of claim 1, wherein the information includes an identification of the asset.

8. A video processing method, comprising the steps of:
capturing a plurality of video images of a roadway;
retrieving information about an asset associated with the roadway, the information including a location of the asset; and
superimposing the information as text onto the video images, the text being disposed at respective positions within the video images, the positions being indicative of the location of the asset relative to the roadway.

9. The method of claim 8, wherein the capturing step is performed by a camera carried by a vehicle along the roadway;

10. The method of claim 9, further comprising the step of determining a plurality of locations of the vehicle in association with the video images captured by the camera.

11. The method of claim 10, wherein the determining is performed by a global positioning system.

12. The method of claim 8, comprising the further steps of:
retrieving a name of a street that crosses the roadway; and
superimposing the name as text onto the video images.

13. The method of claim 8, comprising the further step of superimposing an arrow on the video images, the arrow pointing to the location of the asset.

14. The method of claim 8, comprising the further step of exporting the video images with the text information superimposed thereon to a digital video disc.

15. The method of claim 8, comprising the further step of exporting the video images with the text information superimposed thereon to the Internet.

16. The method of claim 8, wherein the information includes an identification of the asset.

17. A video arrangement, comprising:
a camera configured to capture video images of an external environment as the camera is carried by a motor vehicle;
means for determining a plurality of locations of the vehicle in association with the video images captured by the camera; and
a video processing circuit configured to:
retrieve information about an asset associated with the external environment, the information including a location of the asset; and
superimpose the information as text onto the video images, the text being disposed at respective positions within the video images, the positions being indicative of the location of the asset within the video frames.

18. The arrangement of claim 17, wherein the video processor is configured to superimpose an arrow on the video images, the arrow pointing to the location of the asset.

19. The arrangement of claim 17, wherein the video processing circuit is configured to export the video images with the text information superimposed thereon to a digital video disc and/or to the Internet.

20. The arrangement of claim 17, wherein the information includes an identification of the asset.
